(19) United States
(12) Patent Application Publication
(10) Pub. No.: US 2025/0225316 A1
(43) Pub. Date: Jul. 10, 2025

(54) Generative AI With Specific, Auditable Citation References

(71) Applicant: 2nd Chair LLC, Bellevue, WA (US)

(72) Inventors: Andrew Daniel Kirstensen, Seattle, WA (US); Austin Michael Brittenham, Oxford, MS (US)

(73) Assignee: 2nd Chair, LLC, Bellevue, WA (US)

(21) Appl. No.: 18/909,242

(22) Filed: Oct. 8, 2024

Related U.S. Application Data
(60) Provisional application No. 63/619,257, filed on Jan. 9, 2024.

(51) Int. Cl. G06F 40/166; G06F 40/35

(52) U.S. Cl. CPC G06F 40/166; G06F 40/35

(57) ABSTRACT

According to aspects of the disclosed subject matter, systems and methods for providing a generated response to an input prompt are presented, where the generated response includes auditable, specific citations to one or more content sources. Moreover, and in various embodiments, the generated responses may utilize, in whole or in part, user-supplied content and/or user-identified content as content sources for responding to an input prompt.

### REFERENCE TO RELATED APPLICATIONS

This application claims priority to U.S. Provisional Patent Application No. 63/619,257, filed Jan. 9, 2024, the entirety is incorporated herein by reference.

### BACKGROUND OF THE INVENTION

Knowledge workers, including lawyers, educators, scientific writers, and the like, would often want to make use of an emerging technology referred to as generative artificial intelligence (AI). The desire stems from the thought that the use of generative artificial intelligence (GAI) tools would increase the efficiency of their work. GAI tools, i.e., services such as the product, ChatGPT, are encoded and trained to generate content in response to user-supplied questions, commonly referred to as “input prompts.” Overall, many see GAI as a great boon to various professions, with the hopes that these professions will be able to advantageously utilize and rely on the AI-generated content such GAI tools produce.

When interacting with a GAI tool, a user provides their “input prompt” and, in response, is provided generated content by the GAI tool. However, this generated response may or may not be very helpful. Indeed, it is well documented that GAI tools can (and often do) generate wrong and/or factually incorrect responses. Colloquially, these incorrect responses are referred to as “hallucinations.” Given this, many knowledge workers simply cannot rely on AI-generated content, at least not without a thorough, manual review with corresponding manual editing and correction. Indeed, in fields where rigorous adherence to supportable, factual information is required, the knowledge worker would need to scrupulously examine and vet everything that was generated by the GAI engine. For these more rigorous fields, when one is looking to improve performance, it is a step in the wrong direction to start with the output of a GAI tool that requires line by line verification that all information is factually accurate.

Another issue that limits the use of GAI tools is that these tools largely make use of data that is publicly available on the Internet. While the use of publicly available data sources makes GAI tools useful as a better form of a web search, generally the data sources that are relied upon do not meet the rigorous requirements and vetting of knowledge workers in many fields.

Another limiting feature of current GAI tools is that they rely on the content sources that they have or have available. In other words, a user is not able to indicate to a GAI tool which content source, file, which publicly accessible website, and/or which types of documents the GAI tool may rely on to generate data in response to an input prompt. Currently, no current GAI too allows for the identifying a set of source content, including a users' own source material, from which to generate a response to an input prompt. This limits the usefulness of GAI tools in those professions, such as the legal market and the like, where these tools must be built to be compliant with high scrutiny for content authenticity and accuracy, data security and data privacy. Users in these highly rigorous fields want GAI tools that not just operating on general webpages across the Internet, but on their own internal files, and/or specific sets of content items/files that meet their standards, many of which may be maintained by premium (paid) sites.

Another limiting feature of current GAI tools is that they generally do not identify specific locations in content sources where supporting subject matter is located, including the exact page, paragraph, section, and/or line where supporting source material can be found. Current GAI tools also fail to provide (or at least identify) specific quotes from such source content items, even though such citation information would be highly useful in many situations. Indeed, in the rare circumstance where a content source is identified, not knowing what part (where) of the content source the supporting content is found makes the citation to a content source nearly useless, especially when that content source is significant in size. If a large file is references, the user would still have to go search that file to find the specific content of the serves as the basis of a generated response. Manually locating content is an arduous, productivity-destroying task. Thus, the ability to drill down to the page, paragraph, section, title, caption, line or sentence that was relied upon to produce some element of a generated response is nearly impossible wherein the only metric for source verification is the identity of the content source itself, not a specific location within the content source.

As GAI tools fail to provide specific citations to supporting material in content source items, there is simply no reasonable means to audit any particular citation that a GAI too may include in a generated response. In contrast, in many markets and professions, including the legal profession, citations to supporting content must comply with a high degree of scrutiny and auditability to ensure the authenticity and accuracy of any given statement.

### SUMMARY OF THE INVENTION

According to aspects of the disclosed subject matter, systems and methods for providing a generated response to an input prompt are presented, where the generated response includes auditable, specific citations to one or more content sources. Moreover, and in various embodiments, the generated responses may utilize, in whole or in part, user-supplied content and/or user-identified content as content sources for responding to an input prompt.

In accordance with aspects of the disclosed subject matter, a computer-implemented method that provides generated to an input prompt is presented. Moreover, in various embodiments, the generated response includes at least one specific to citation content in a content source. In execution, an input prompt requesting a generated response regarding at least a first topic is received from the user, the requesting being for a generated response. The input prompt is provided to the generative engine. Moreover, the input prompt provided to the generative engine includes instructions to the generative engine to include, in the generated response, one or more specific citations to citation content in a content source. In response to the input prompt, the generated response is received, which response includes at least one specific citation to citation content in a content source. A relevance score is associated with each citation in the generated response, including the at least one specific citation. Thereafter, the generated response is provided to the user.

In accordance with additional aspects of the disclosed subject matter, a computer-implemented method, and a computer-implemented system, for responding to a user's input prompt with a generated response are presented. In execution, an input prompt is received from a user over a communication network, the input prompt being a request for a generated response with respect to a first topic. The input prompt is preprocessed to ensure that the input prompt includes instructions to a generative engine to include at least one specific citation in the generated response. The input prompt is then provided to a generative engine, and in response, a generated response is received from the generative engine. According to the instructions, the generated response includes at least a first specific citation to citation content of a first content source. A validation is conducted on the at least first specific citation, determining that the cited content of the first specific citation references content of the first content source. A score is associated with the first specific citation based on a relevance analysis of the cited content of the first specific citation and the citation content of the first content source. The generated response is then provided to the user in response to the input prompt.

### BRIEF DESCRIPTION OF FIGURES

The foregoing aspects and many of the attendant advantages of the disclosed subject matter will become more readily appreciated as they are better understood by reference to the following description when taken in conjunction with the following drawings, wherein:

FIG. 1 is a pictorial diagram of a network environment that includes a computer-implemented provenance engine suitably configured to respond to a user's input prompt with a generated response that includes one or more specific citations to supporting content in content sources, all in accordance with aspects of the disclosed subject matter;

FIG. 2 is a pictorial diagram illustrating exemplary components of a provenance engine, suitably configured to respond to a user's input prompt with a generated response that includes one or more specific citations to content source items, all in accordance with aspects of the disclosed subject matter;

FIG. 3 is a flow diagram illustrating an exemplary method for preprocessing one or more content source items to pre-identify and store the relative boundaries of chunks of each content source for use in specific citations, all in accordance with aspects of the disclosed subject matter;

FIG. 4 is a flow diagram illustrating an exemplary routine, as executed by a provenance engine, to response to a user's input prompt with generated content, in accordance with aspects of the disclosed subject matter;

FIG. 5 is a flow diagram illustrating an exemplary routine, as executed by a provenance engine, for obtaining access credentials to a content source, in accordance with aspects of the disclosed subject matter;

FIG. 6 is a flow diagram illustrating an exemplary routine, as executed by a provenance engine, for presenting particular citation content of a specific citation to a user, in accordance with aspects of the disclosed subject matter;

FIG. 7 is a block diagram illustrating an exemplary organization of computer-readable medium that bears computer executable instructions for carrying out one or more aspects of the disclosed subject matter; and

FIG. 8 is a block diagram illustrating exemplary components of a computer system hosting and implementing elements of a provenance engine in accordance with aspects of the disclosed subject matter.

### DETAILED DESCRIPTION

By way of definition and clarity for this disclosure, the term “citation” should be understood and interpreted to mean a reference to a content source that is purported to be support for a portion of generated content to which the citation is associated. Further, the term “specific citation” should be understood and interpreted to mean a reference that particularly identifies a specific portion of the content source that is the basis for the content, as generated in response to an input prompt, to which the specific citation is associated.

By way of definition and clarity for this disclosure, the term “cited content” should be understood and interpreted to mean a portion of content to which a citation referencing second content is associated. The citation associated with the cited content may be a specific citation, i.e., identifying a specific portion of the referenced content that is the basis for the content. The term “citation content” should be interpreted as being the second content, i.e., the content referenced by a citation. It is the citation content in which the specific content of a specific citation is located.

To illustrate the above definitions, consider the following text as an example of generated content to which a specific citation:

“Even when it is demonstrated that no one outside of an organization has ever viewed its production process, it is not persuasive. Open and non-secret use of a claimed process used in the course of producing items for commercial purposes is considered ‘public use.’ [Electric Storage Battery Co. v. Shimadzu, 307 U.S. 5, 20 (1939)]”.

With respect to the above example, “Open and non-secret use of a claimed process used in the course of producing items for commercial purposes is considered ‘public use’”, represents the cited content. The section of content, “[Electric Storage Battery Co. v. Shimadzu, 307 U.S. 5, 20 (1939)]”, is the citation, i.e., the reference to source content supporting the statement made by the cited content. Moreover, this citation is a specific citation as it identifies a portion, i.e., “5, 20”, within the citation content, i.e., the published case, Electric Storage Battery Co. v. Shimadzu, where support for the cited content is specifically found. Finally, the published case within the citation, i.e., Electric Storage Battery Co. v. Shimadzu, is the citation content.

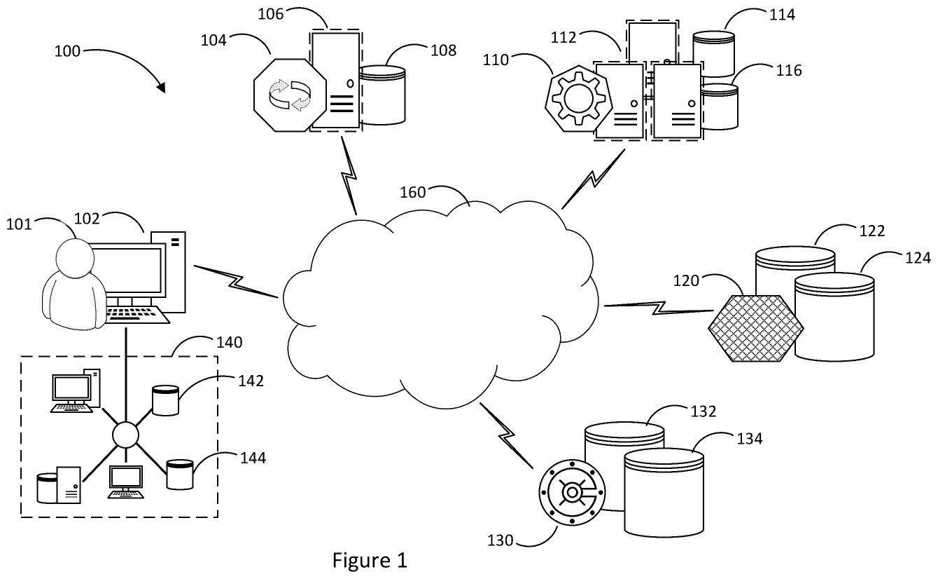

To further set forth aspects and elements of the disclosed subject matter, reference is now made to the figures. Turning to FIG. 1, this figure is a pictorial diagram of a network environment 100 that includes a provenance engine 104 operating on at least one computer device 106, the provenance engine being suitably configured to respond to a user's input prompt with a generated response that includes one or more specific citations to content sources, all in accordance with aspects of the disclosed subject matter.

In this figure, a person (referred to as a computer user, or more simply, a user), such as user 101, enters an input prompt for generated data that will include at least one specific citation to source content and submits this input prompt over a network 160 to a provenance engine 104. In various embodiments, the provenance engine receives the input prompt from the user and preprocesses it to determine and ensure that citations (including one or more specific citations) will be included in or with any generated response, and the appropriate source content items will be utilized in the generation that response.

After having preprocessed, as needed, the input prompt, the provenance submits the input prompt to a generative engine. In various embodiments, this generative engine, such as generative engine 110, is a GAI process/tool. Additionally, while in FIG. 1 the generative engine 110 is illustrated as an external service or tool to the provenance engine 104, in alternative embodiments the provenance engine may include, among its own tools and/or services, a generative engine that can generate a response to an input prompt which includes one or more specific citations. Irrespective of whether the input prompt is processed by the provenance engine's own generative engine, or by an external generative engine, with the response generated, it is then returned, via network 160, to the user.

Optionally, the provenance engine may validate and/or score each citation in the generated response. These optional actions are typically, though not exclusively, conducted prior to providing the generated response to the user 101, though such activities may be taken in a just-in-time manner as the user attempts to view such information while viewing the generated response. Validating ensures that citation content, referenced in the generated response, is not a “hallucination” and that the referenced content source is among the content source items that are to be relied upon. Scoring refers to associating a score indicative of the relevance of the citation content to the cited content.

Regarding generative engine 110 of FIG. 1, while it is shown as operating on a computer system 112 comprising multiple computers and associated with its own data sources 114 and 116, this is illustrative and should not viewed as limiting upon the disclosed subject matter.

According to aspects of the disclosed subject matter, a suitably configured provenance engine, such as provenance engine 104, may indicate to the generative engine (either local or external to the provenance engine) which content source items should be used in generating a response to an input prompt, as well a rank among the indicated content sources that provides a preference as to which content sources should preferably be relied upon when multiple options are available. This indication of content source items may be based on a user-supplied list of content source items (typically references to content source items), lists associated with the user and maintained by the provenance engine in its local data stores, such as data store 108, default lists established with the provenance engine for entities and/or organizations, and the like. Lists of content source items may be exclusive, i.e., indicating that only content source items referenced by the list may be used, or preferred, i.e., indicating that use of the content source items in the list should prioritized over content source items not on the list. In various embodiments, a list of content source items may include exclusion information indicating content source items are not to be relied upon in generating a response. Multiple lists of content source items may be applied, i.e., the use of a user list and a company list.

Regarding the ordering of content source items and according to aspects of the disclosed subject matter, as mentioned the various lists of content source items may be ranked such that reliance upon a higher ranked content source item is made over another content source item of a lesser ordered content source in generating the response to an input prompt, so long as both serve the intended purpose of the generative engine. Illustratively, when not restricted to only those content source items identified in the one or more lists, reliance upon content source items not identified by any list may be made when the content source items of the various lists do not provide the support or basis that is needed by the generative engine in generating a response to an input prompt

While a wide variety of content source items could be used to generate a response to an input prompt (the Internet is full of content source items that are readily available), not all available content source items should be used. Indeed, in many contexts, such as a legal context, not all available content sources are viewed as being authoritative and/or reliable or may be viewed as being less authoritative/reliable than other available content sources. To ensure that the “best” content sources are relied upon in generating a response, and according to aspects and embodiments of the disclosed subject matter, one or more lists of content source items may be associated with a given input prompt for directing, prioritizing, and/or constraining the generative engine to particular content source items that are to be relied upon in generating the response to an input prompt.

According to aspects of the disclosed subject matter, the one or more lists of content source items may reference files, graphs, images and/or data that are stored or accessible from a variety of disparate locations and networks. For example, and by way of illustration and not limitation, content source items may be stored locally to the provenance engine in one or more data stores, such as in data store 108. Additionally or alternatively, content source items may be accessed from a variety of locations including, by way of illustration and not limitation: content stores maintained by a third-party generative engine, such as (illustratively) the content stores 114 and 116 associated with generative engine 110; content source items maintained by third-party data services such as data stores 122 and 124 associated with data service 120; content stores maintained by subscription services such as content stores 132 and 134 of subscription service 130; as well as on data stores on a local area network of the user, such as data stores 142 and 144 of local area network 140. Variations and combinations of content source items from the various sources and services maintaining source content items are anticipated for generating a response to any given user's input prompt.

In various embodiments of the disclosed subject matter, the provenance engine 104 may conduct pre-generation processing with respect to the location of the various content sources to ensure that access to the identified content sources in the list may be granted. However, in some embodiments of the disclosed subject matter, the provenance engine and/or the generative engine, such as generative engine 110, may in the course of generating a response, query the requesting user for access credentials to restricted/subscription services, such as subscription service 130.

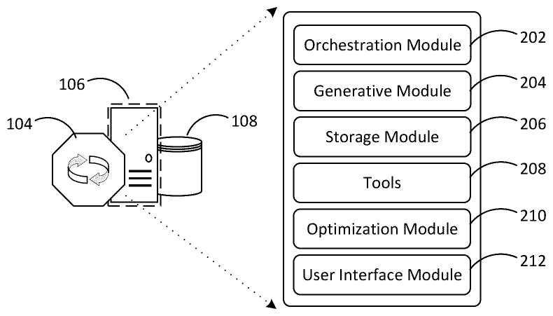

To further illustrate aspects of the provenance engine 104, reference is now made to FIG. 2. As indicated above, FIG. 2 is a pictorial diagram illustrating exemplary, executable components of a provenance engine 104, suitably configured to respond to a user's input prompt with a generated response that includes one or more specific citations to content sources, all in accordance with aspects of the disclosed subject matter.

According to aspects of the disclosed subject matter, a provenance engine 104 includes various executable components that, cooperatively, respond to an input prompt from a user, such as user 101, preprocess the input prompt as needed to obtain desired results, and obtain (directly and/or indirectly) a generated response to the input prompt from a generative engine, which generated response includes at least one specific citation to source content, and returns the generated response to the user. These modules include an orchestration module, 202, a generative module 204, a storage module 206, a tools module 208, an optimization module 210, and a user interface module 212.

Regarding orchestration module 202, this module is the coordinating component for processing the input prompt to a generated response and returning the generated response to the requesting user. As elements of managing the overall process, orchestration module 202 delegates certain tasks to certain other subprocesses and controls the dataflows at the highest level. Delegated tasks from the orchestration module may include defining one or more lists of content source items for use in generating the response to the input prompt, preprocessing the input prompt to obtain the desired generative result that includes one or more specific citations, obtaining or retrieving access credentials for restricted/subscription content source services, identifying a generative engine, such as generative engine 110 of FIG. 1, to process the input prompt, obtaining relevant processing context (of prior interactions) for the requesting user, accessing short-term user interaction data (maintained in a local data store 108), validating and scoring the citations of a generated response, presenting the generated response to a user, and the like. Many, if not all the various delegated tasks are executed through other modules of the provenance engine, and their components, including elements of the tools module 208, the user interface module 212 and the storage module 206.

In various implementations of the disclosed subject matter, the orchestration module 202, as well as most if not all modules of the provenance engine, is written in the Python language. While the provenance engine may be implemented in any number of alternative languages for execution on a computer system, such as computer system 106, a Python language implementation provides conveniences not as readily available in other programming/development languages. A significant convenience arises from Python's dominance as the primary language of machine learning (ML), large language models (LLMs), and Natural Language Processing models (NLPs), with an extensive number of libraries written in Python that may be advantageously utilized.

Turning to the generative module 204, in various embodiments of the disclosed subject matter, the generative module 202 may operate as the interface between the provenance engine 104 and an external generative engine, such as generative engine 110 of FIG. 1. Alternatively, the generative module 202 includes its own trained generative engine which the generative module executes to generate a response to an input prompt.

In aspects of the disclosed subject matter, the generative module 204 may utilize one or more tools of the tool module 208 to preprocess and update the input prompt so that the generative engine (irrespective of whether it is a local generative engine or a third-party generative engine) generates a response with one or more specific citations to supporting content sources. The generative module further interfaces with the generative engine to identifies content sources to be used as may be identified in one or more lists of content, segment/chunk information (as described below) to facilitate the generation of specific citations, and the like. Generally speaking, the generative module 202 may performs tasks related to interfacing with a generative engine, input prompt preprocessing and reframing, and the like.

According to aspects of the disclosed subject matter, generative module 204 may be configured to be agnostic of the actual generative engine to be used. Advantageously, this enables the provenance engine 104 to utilize, according to specific needs, nearly any generative engine available and accessible. Examples of potential generative engines include, by way of illustration and not limitation, Anthropic's Claude, the various iterations of OpenAI's GPT, as well as generative engines that are self-hosting such as Llama2, Mixtral models, and Falcon. In at least one embodiment, the generative module interacts with a version of OpenAI's GPT.

According to additional aspects of the disclosed subject matter, a generative engine, wherein it is a self-hosting generative engine or a third-party generative engine, may include quoted content as part of the citation content in a generated response. Typically, and according to aspects of the disclosed subject matter, the quoted material within the generated response will be associated with a specific citation referring to citation content in a content source from whence the quoted material is copied/quoted.

The storage module 206 manages the handling and management of data needed and used by the provenance engine, including the short-term user interaction data which can be used by the generative engine to establish context and meaning to the input prompt. The data managed by the storage module may include, in addition to the user interaction data already mentioned, content source items and parsed content. Regarding the content source items, whether stored locally to the provenance engine 104 in its data store 108, or linked to remotely story data by data services, such as data service 120, subscription service 130, or links to content source items on a local network 140 of the user, the storage module maintains the various content source items (or links to the content source items) that are used by a generative engine to respond to an input request.

In addition to the content source items, storage module 206 further manages the storage of parsed content. Parsing is understood to be a term of computer science where a stream of content is analyzed into individual atomic units called parsed tokens. “Chunking” is a term in computer science where the parsed tokens are collected into sub-units for independent processing. Accordingly, the term “chunk” is the smallest processable unit by the provenance engine comprised of a number of parsed tokens from the content source. According to aspects of the disclosed subject matter, content source items are parsed to identify “chunks” of content within each item and the boundaries or extents of these chunks, relative to the content source in which they are included, is captured. The content source items are parsed according to existing segments and sections of each content source. Any given content source item may be parsed according to paragraphs, sections (chapters, graphics, tables, lists, captions, titles, footnotes, etc.), quoted material, and the like within the item. As suggested, the boundaries of each parsed segment, relative to the content source item, is recorded. Advantageously, this parsed/chunked information serves to enable ready access to specific citation

In addition to information indicating the location or boundaries of a “chunk” within a content source, information regarding the segment corresponding to the chunk may also be associated with information, including identifying the type of subject matter that is found in the chunk. Each different type of these chunks typically requires its own storage solution, as many existing tools have been built to cater to specific data types. For example, for vector embeddings one might use Pinecone, Chroma, or Weaviate, as well as Google and Microsoft built solutions. For segments of graphical data, a solution such as Neo4j may be used, especially as it is designed to handle graphical querying. With segments of NER data, tuples of values/segments may be stored by AWS, thereby bridging a gap between the source and parsed data distinctions. In one embodiment of the disclosed subject matter, AWS is used as a primary cloud storage platform to handle the storage content sources, and Pinecone is used for vector storage.

While shown in FIGS. 1 and 2 as being stored in a local data store 108 to the provenance engine, this should be viewed as illustrative and not limiting upon the disclosed subject matter. In various embodiments, storage of the content source items and/or links to content source items may be stored locally and/or using cloud platforms, such as Amazon's AWS, Google's Cloud Platform (GCP), Microsoft's Azure Cloud, and the like.

The tools module 208 is a general module comprising a variety of executable processes used in the execution of the provenance engine. Executable tools for preprocessing an input prompt, citation relevancy scoring and validation, segmenting a content source into chunks and capturing the boundaries, and the like are included in the tools module.

The optimization module 210 is an optional module whose purpose is to optimize the generated responses and the accuracy of specification citations in the generated responses. This module is used to improve the provenance engine's ability to obtain high quality generated responses from a generative engine. To optimize and refine the generated responses with specific citations, the optimization module maintains a dataset of training entries, each having the following structure: an input prompt; a set of content source items, and a subset of content source items that are relevant to the input prompt. Using the training entries in this dataset, the optimization module fine-tunes a generative engine to a generate response with specific citations. This training/fine-tuning is often a continuous or periodic process that is carried out to ensure that generative engine provides the best possible responses and is particularly carried out as additional/new training entries are available and added.

Regarding the training entries dataset, an initial set of training entries are used, where the input prompts and the set of content source items are manually curated, as well as the subset of content source items that are viewed as relevant. Often, this dataset of manually curated entries is referred to as “labeled” data. Though producing the dataset of labeled can be time consuming, this initial dataset is a “gold standard” for training a generative engine. User interaction with a generative engine is the typical manner for establishing this dataset. Indeed, to create this manually curated dataset, or to enhance the dataset, each time a user interacts with the generative engine, the interaction (the input prompt, the content source items and the subset of relevant content sources) is captured. For each interaction, the content source items are also retrieved by the optimization module 210 and processed by the storage module 206, as well as the citations added in the generated response. For each interaction, the submitting user also rates the accuracy of the citations, to create the labeled dataset of training entries. Additionally, while positive training entries (the “labeled” referencing citation reference items with high relevance and accurate specific citations) have been described above, negative training entries (i.e., referencing citation reference items with lower relevance and/or inaccurate or non-specific citations) may also be used as training data for refining the accuracy of the generative engine.

The user interface module 212 is the primary interface through which users, such as user 101 of FIG. 1, interact with the provenance engine 104. In various implementations of the disclosed subject matter, the user interface module includes the interface and controls for a user to submit an input prompt to the provenance engine, and to receive the generated response, which includes one or more specific citations, to the user. In various non-limiting embodiments, a view would display both the user's input prompt with the generated response presented immediately below.

Within this generated response, and according to aspects of the disclosed subject matter, portions of the generated response that are sourced from one or more content sources will be associated with a specific citation to the supporting content source. Per the definitions above, these portions in the generated response are cited content in the generated response, and at least one of the citations is a specific citation that corresponds to a specific location within the citation-reference content source item. In various embodiments, the cited content may be highlighted for ready identification within the generated response.

According to various aspects and embodiments of the disclosed subject matter, the cited content portions of a generated response may be configured to be user inter-actionable such that as a user interacts with a highlighted portion, i.e., cited content, of a generated response, a content source viewer is opened, the content source viewer displaying the supporting content source item, i.e., the citation content.

Further, where a citation is a specific citation, the specific area of the content source item is located and positioned for presentation in the content source viewer, facilitating the user's review of the citation. By way of illustration and not limitation, if the citation content of a specific citation were located on page 6, and particularly some lines of text on the bottom half of page 6, the content source viewer would position the content source's sixth page for display and would particularly position the text on the bottom half of the page (i.e., the citation content.) In additional embodiments, an indication, e.g., an outlining box in the content source viewer, would indicate the exact citation content that was relied upon in putting together the generated response.

Advantageously and according to aspects of the disclosed subject matter, the ability to open and review the citations within a generated response provide a key feature: the ability to audit whether or not a given citation actually corresponds to a content source item and, additionally, the ability to manually audit whether or not the specific citation content is relevant to the input query. Indeed, in attempting to open the content source in the content source view, an error would occur if the citation content/referenced content source does not actually exist (as opposed to an error in a current ability to access the content source.)

Additionally, an audit as to the relevancy of the citation content to the input query may be made by the user, i.e., an evaluation of the relevancy of the citation content to the input query to the cited content in the generated response, as well as to the overall input prompt. In addition to showing a first citation source as support for content in the generated response, and according to aspects of the disclosed subject matter, the user interface module may further present a means, such as displaying a list of tabs, that illustrate other content sources within that sourced block/cited content. When a user clicks one of the other tabs for a different citation, that content within the corresponding content source that support the cited content in the generated response, as well as a box overlay will be positioned and presented within the viewer, again indicating to the user where in this new content source the citation content is found.

In addition to the features described above, the user interface module 212 may be also configured to display a relevancy score for each citation with the generated response. According to aspects of the disclosed subject matter, the relevancy score is made by conducting a similarity evaluation between the cited content (i.e., content in the generated response) and the citation content (i.e., content referenced within a content source), where higher relevancy scores are desired.

As indicated above, a user may identify content sources (e.g., files, documents) to be used by the provenance engine 104 in generating a response to an input prompt. Moreover, a user can submit a list of content sources (also referred to as content source items) to be used either exclusively in responding to an input prompt or considered as preferred content sources to be used in responding to an input prompt. The list of content sources may be ordered/ranked by the user, or simply a collection of content source items to be used as indicated.

According to various aspects of the disclosed subject matter, these content sources, as well as all content sources that are used in responding to an input prompt, are pre-processed or processed in a “just-in-time” manner to be able to provide the basis of specific citations. This processing involves parsing a citation source to determine “chunking” parameters (i.e., parameters that indicate how to subdivide the content source into chunks, to which specific citations may be made), processing the content source using type-appropriate chunking tools into those chunks, and recording the relative positions of each chunk within the content source in a data store, such as data store 108 of FIG. 1.

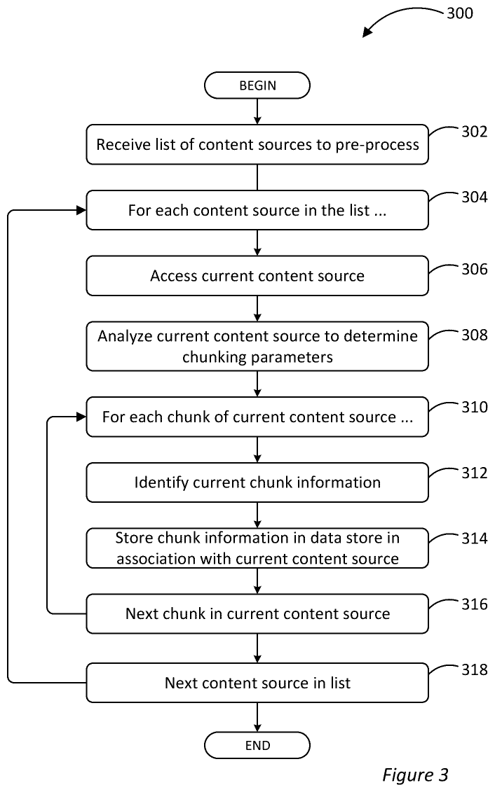

To illustrate the segmentation or “chunking” process, reference is made to FIG. 3. FIG. 3 is a flow diagram illustrating an exemplary method 300 for processing one or more content source items to identify and store the relative boundaries for segments or chunks of each content source for use in specific citations, all in accordance with aspects of the disclosed subject matter. Beginning at block 302, a list of one or more content sources is received. This list may or may not correspond to a list that a user supplies with respect to an input prompt.

At block 304, an iteration loop is begun to iterate through each content source in the received list. As will be readily appreciated, and for purposes of definition of terms used in the steps of the iteration loop, a content source of the list and upon which the processing is actively operating is referred to as the “current content source.” After completing an iteration loop, the next content source in the list becomes the “current content source.”

At block 306, the current content source is accessed. As indicated above, accessing the current content source may involve resolving access control constraints, i.e., authentication of credentials and authorization to restricted current content source. In some embodiments, the provenance engine may already possess the access credentials, stored in its data store 108. Alternatively, the provenance engine may request access credentials for the current content source from the user or other party that can provide the credentials. With access credentials obtained (as needed), the current content source is accessed.

At block 308, the current content source is analyzed to determine chunking parameters and tools for carrying out the chunking/segmenting. The tools correspond to the type (or types) of content present in the current content source, while the chunking parameters correspond to the structure or organization of the current content source, i.e., upon which basis (or bases) the current content source is to be segmented. This analysis considers, by way of illustration and not limitation, the overall size of the current content source, structures that are present in the current content source, natural divisions such as paragraphs, pages, chapters, distinct graphics, tables, and the like. Typically, though not exclusively, the size of the segments or chunks of the current content source will likely vary. Often, especially with respect to text or data sets, the size of a chunk (in the context of textual content) is selected to be within a certain number of “tokens,” i.e., words or parts of words that a generative engine might understand and use as input. Images, graphics, tables, may be viewed as a single chunk or subdivided depending on the specific content item being processed.

At block 310, a second iteration process is begun, this second iteration directed to processing though the content of the current content source to identify chunk information. As a current chunk is identified, at block 312 chunk information for the current chunk or segment, which includes but is not limited to the bounds and relative position of that chunk, is determined. This relative position identifies where, within the current content source the current chunk is located. The bounds identify the area of the current chunk in its relative location. The bounds and relative position typically include information such as, by way of illustration and not limitation, a start page of the current chunk, a page span, the start and end positions of the page upon which the current chunk is found and upon which it ends, column information (in needed), and the like. Advantageously, the chunk information allows for later use to display the specific content within the content source that is relied upon by a specific citation.

At block 314, chunk information of the current chunk is recorded in association with the current content source in a data store, such as data store 108. At block 316, the process returns to block 310 to continue by identifying another chunk of content in the current content source if there is more content to process/chunk. Alternatively, if there is no more content in the current content source to process/chunk, the routine proceeds to block 318.

At block 318, the process returns to block 304 to continue processing the next content source (as the new current content source) in the list. Alternatively, if there are no more content sources in the list to process, the routine 300 terminates.

Regarding the access of content sources, both for pre-processing to determine chunk information for a content source and for generating a response to an input prompt, as mentioned above it should be appreciated that content source items may be found in a variety of network-accessible locations, and that access to any given content source may require specific access credentials, including authentication, and authorization credentials. Irrespective of which operation is in need of the access credentials, and according to aspects of the disclosed subject matter, a callback request (e.g., via presentation by the user interface module 212) can be made to the user requesting access credentials to an otherwise inaccessible content source.

Note that a callback request is a known term in computer science where a first software function or method provides a signal, sometimes known as a semaphore, that triggers the operation of a second function or method that subscribes to the signal. Sometimes callbacks are alternatively referred to as a software eventing system.

In response to the callback request, the user may supply access information that includes information such as, by way of illustration and not limitation, the access location of the content source, access credentials for the content source, privileges associated with the access credentials, second factor authentication information, and the like. This access information can be returned by the user to the process to facilitate access to the content source. Additionally, the received access information may be optionally stored in a data store in association with the user for future reference, obviating the need for obtaining all the information from the user (though second factor authentication, if required, may still require some interaction with the user.)

In various alternative or additional embodiments, the process encountering access restrictions may suggest an alternative source for a content source, and particularly one to which the process that needs access is granted such. This, of course, recognizes that many content sources are available from multiple data stores or data services over the Internet and attached networks. However, suggesting an alternative data store (or data service) for a content source would often require interaction with the user to confirm that use of the content source from the alternative data source is acceptable.

Content source caching may also be implemented according to various embodiments of the disclosed subject matter. Content source caching is a computer implemented practice of storing the location of content, or in some cases the content itself, in a memory location, a memory location that is more quickly accessed than the location or the content is originally stored. This so-called cached storage enables software to call the cache for the stored information thereby saving processing and access time and improving responsiveness of the overall system. Indeed, after gaining access to access-restricted content, the provenance engine may store, in a cache, the content source for future use by the specific user for which the initial access was made, i.e., user-specific content source caching. Caching is especially useful as people often make the same or similar queries, often as a refinement process in order to obtain exactly what is sought.

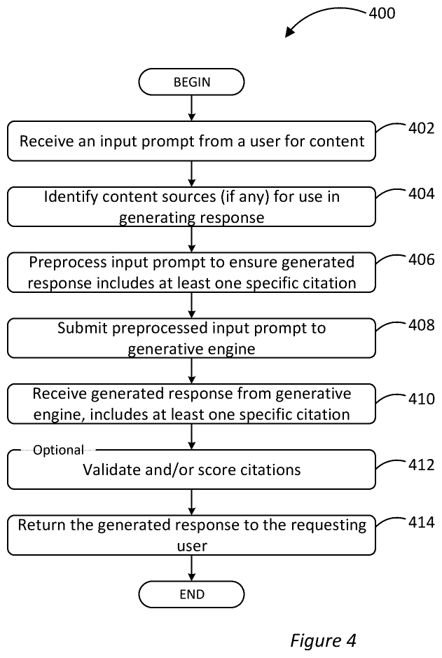

Turning now to FIG. 4, FIG. 4 is a flow diagram illustrating an exemplary routine 400, as executed by a provenance engine operating on a computer system (such as provenance engine 104 of FIG. 1), to response to a user's input prompt with generated content. Beginning at block 402, the provenance engine 104 receives an input prompt from a user 101, as submitted to the provenance engine via the user's computer 102 over a network, such as network 160. As indicated above, in addition to describing the information that is sought, the input prompt may include or be accompanied by one or more lists of content sources upon which the generative engine will preferrable, or even must, base its generated response. As indicated above, the one or more lists of content sources, including any cached lists, may include ranked/ordered content sources which the generative engine adheres to in generating a response to the input prompt.

At block 404, content source items from a received list of content source items, and/or from a cached list of content source items stored by the provenance engine are identified. This includes any ordering/ranking that applies to the content sources. At block 406, the input prompt is preprocessed, as necessary, in order to elicit a desired response which includes at least one specific citation in the generated response. With respect to this preprocessing, as will likely be appreciated by those skilled in the art, an important feature in obtaining the desired generated response, e.g., a generated response with specific citations, is having an appropriately configured input prompt that will direct the generative engine to do so.

Often, a user submitting an input prompt will likely not include the request or instructions needed to obtain the desired response from a generative engine, including instructions to include one or more specific citations in the generated response. Accordingly, the provenance engine 104 preprocesses the input prompt, as needed, to appropriately configure the input prompt. Often, though not exclusively, the configurations and instructions to obtain a generated response with specific citation is the result of a previously-executed iterative process by which the configurations and/or instructions needed to obtain the desired results are determined. This iterative process of refining input prompts to determine the configurations and instructions to get the desired result is referred to as prompt engineering.

At block 408, the updated/configured input prompt, along with any other information including one or more lists of content source items, is submitted to the generative engine, such as generative engine 110 of FIG. 1. At block 410, based on the input prompt and any additional instructions provided by the provenance engine 104 to the generative engine 110, including a list of content source items, the generative engine creates a generated response which includes at list one specific citation to a content source, and returns the generated response to the provenance engine.

Optionally, at block 412, all citations in the generated response, including all specific citations, may be validated and/or scored. With respect to validating each citation, the process evaluates that the citation content of each citation exists, as well as ensuring that the citation content that is alleged to exist within the referenced content source also exists. This validation may include determining whether the citation source is one of the identified citation sources that should be exclusively referenced. While not illustrated in routine 400, corrective action may be taken when it is found that the generative engine has failed to comply with specific requirements of the input prompt and/or “hallucinated” a citation source.

Similarly, to assure the user that the citations are high quality, the provenance engine may rank or score each citation. According to aspects of the disclosed subject matter, scoring (or ranking) a citation includes accessing the cited content, accessing the citation content, and executing a semantic similarity analysis to determine a score representing a semantic similarity between the two. In various embodiments of the disclosed subject matter, the semantic similarity analysis is carried out by a trained large language model (LLM). Note that an LLM may generally operate in conjunction with a reward model (RM), which is a separately trained neural net specific embodying training to bias or tailor the output of an LLM specific to the needs of an application. Indeed, in various embodiments, the RM may perform the semantic similarity analysis on behalf of the LLM. Further note that an LLM may generally operate in conjunction with an LLM Agent which may be suitably configured and trained to provide processing, often preprocessing, of input prompts, outputs, or both. Accordingly, the LLM Agent may perform the semantic similarity on behalf of the LLM. In alternative embodiments, the semantic similarity analysis is carried out by a trained machine learning model (ML) that projects the citation content and the cited content into a multi-dimensional space and determines a similarity value according to a similarity measure, e.g., a cosine similarity measure. Further, an evaluation as to the ordered position of the citation source among all content sources that were identified for use vs. the rank of the other citation sources may be considered in generating the “score.” This latter ensures that higher ranked citation sources are utilized and relied upon appropriately.

At block 414 the generated response is returned to the submitting user and the routine 400 terminates.

Regarding the routine/process 400 above, of course there may be occasions where the generated respond does not quite satisfy the purposes of the user submitting the input prompt. In such instances, the user may modify the input prompt by adding additional information, further instructions, reorder, limit or expand the list of content sources, and the like, and then resubmit their updated input prompt. The provenance engine 104, utilizing its caching ability, could complete any additional pre-processing, submit the updated input prompt to the generative engine, and return the generated response. These iterations may be carried out by the user until the user is satisfied with the results.

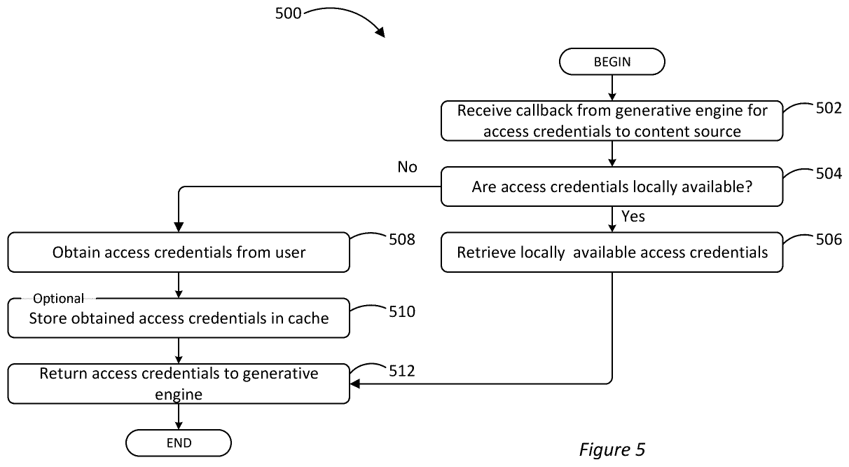

As mentioned above with respect to the various content sources to be used, often there may be instances in which access to any given content source is restricted by some type of access control. In these situations, and especially as the user expects the generative engine to utilize content sources identified by the one or more lists of content sources, it is important to be able to obtain such access credentials to these content sources. FIG. 5 is a flow diagram illustrating an exemplary routine 500, as executed by a provenance engine, for obtaining access credentials to a content source, in accordance with aspects of the disclosed subject matter.

Beginning at block 502, after having submitted an input prompt to the generative engine, the provenance engine 104 may receive a callback message from the generative engine requesting access credentials for a content source. At decision block 504, a determination is made as to whether access credentials are locally cached by the provenance engine, often though not exclusively stored in a data store in association with the submitting user. Of course, access credentials for any given content source may include, by way of illustration and not limitation, personal access credentials (i.e., personal to the submitting user), corporate and/or organization credentials.

If, at decision block 504, the access credentials are locally available, the process 500 moves to block 506. At block 506, the locally available access credentials are retrieved/obtained, and at block 512, the access credentials are returned (as a response to the callback) to the generative engine. Alternatively, at block 504, if the access credentials are not locally available, the process moves to block 508. At block 508, the access credentials are obtained from the user through interaction between the provenance engine and the user. Once obtained from the user, at block 510 the access credentials are optionally stored in the provenance engine's cache in association with the user. At block 512, the access credentials are supplied to the generative engine. Thereafter, the routine 500 terminates.

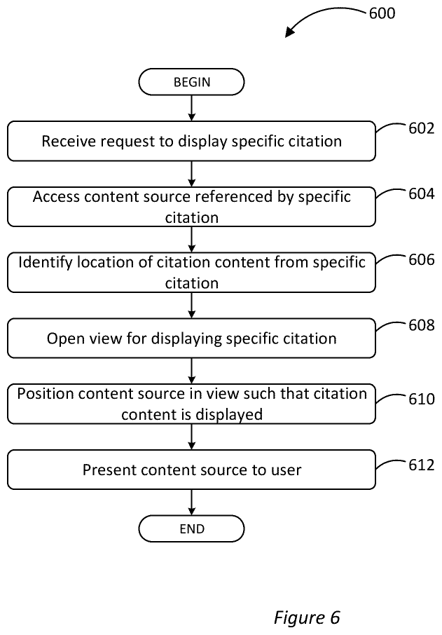

As discussed above, one of the advantages of a specific citation is the ability to readily identify the particular citation content relied upon by the generative engine within a content source, and particular with respect to presenting the content to a user for review and/or consideration. To this end, FIG. 6 is a flow diagram illustrating an exemplary routine 600, as executed by a provenance engine, for displaying specific citation content of a generated response to a user, in accordance with aspects of the disclosed subject matter.

Beginning at block 602, a request to display the content of a specific citation in a generated response is received from a user. At block 604, the content source referenced by the specific citation is accessed (which may include obtaining access credentials to display the content to the user.)

At block 606, the relative location of the citation content is identified using both the information of the citation as well as chunking/segment information for the content source. At block 608, a view for presenting the specific citation is created/opened and, at block 610, the content source is loaded into the view and positioned within the view such the citation content is displayed. At block 612, the view of the specific citation is presented to the user. Thereafter, the routine 600 terminates.

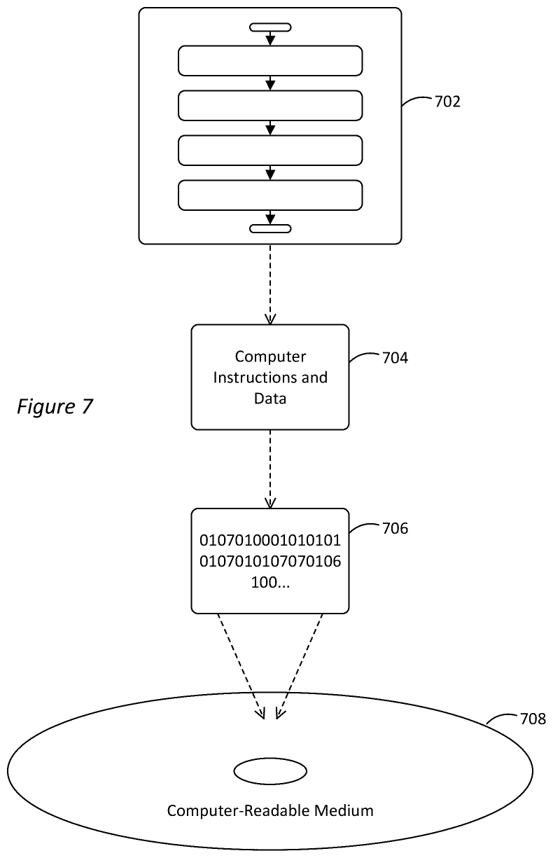

FIG. 7 is a block diagram illustrating an exemplary organization of a computer-readable medium 708 bearing computer executable instructions 706 for carrying out one or more aspects of the disclosed subject matter, and particularly the operation of the provenance engine 104. As will be appreciated by those skilled in the art, while FIG. 6 illustrates the computer-readable medium 708 as an exemplary optical disc (e.g., a CD-R, DVD-R or a platter of a hard disk drive), non-limiting examples of a computer-readable medium (or media) include optical media (e.g., compact discs, “CDs”, in various writable and/or non-writable forms, digital versatile discs, “DVDs” in their various writeable and/or non-writable forms, etc.), solid-state memory devices (e.g., USB “thumb” drives, flash memory cards or devices, etc.), magnetic discs and magnetic tapes, read-only cartridge devices, magnetic fixed-disc hard drives, and the like.

While computer-readable medium may be both transitory and non-transitory with respect to data storage, for purposes of the disclosed subject matter and unless specifically stated otherwise, computer-readable medium (or computer-readable media) should be interpreted as being non-transitory, i.e., stores data in a non-transitory manner. Of course, transitory memory refers to the fact that the data (and/or instructions) is stored only so long as power is supplied to the memory, whereas non-transitory memory retains and stores data (and/or instructions) even when power is not supplied to the memory.

The computer-readable data 706, in turn, correspond to computer-executable instructions and data 704 that, when executed by a processor of a computer, operate according to one or more of the embodiments described above with respect to the operation and function of the provenance engine 104. Indeed, the computer-executable instructions 704 may be configured to perform exemplary methods 300, 400, 500 and 600, for example and without limitation. In another such embodiment, the computer-executable instructions 704 may be also configured to implement logical elements of a computing system, such as at least some of the exemplary computing system 800, as described below that carry out the functions of a provenance engine. The logical steps and/or computer-executable instructions are indicated by the logical elements 702.

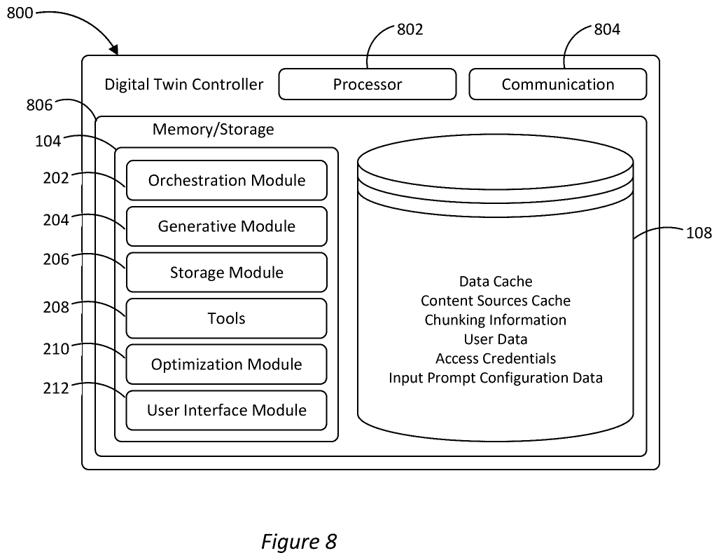

FIG. 8 is a block diagram illustrating exemplary components of a computer system suitable for hosting and implementing a provenance engine in accordance with aspects of the disclosed subject matter. Suitable computer systems include, by way of illustration and not limitation, desktop and laptop computers, tablet computer systems, handheld mobile computing devices, online computing platforms (often referred to as cloud computing services such as AWS (Amazon Web Services) and Microsoft's Asure cloud services), distributed computing devices/computers, and the link.

A suitable computer system, as illustrated in FIG. 8, will include at least one processor 802 and one or more memory and/or storage units, such as memory 806, as well as other components that carry out various features of a computer/computing service.

Among the various components of the computer system 800 is a communication component 804 that comprises the necessary hardware and software components to communicate with other devices and/or other computers to carry out the various functions of a provenance engine. In some embodiments, this communication component is referred to as a NIC (network interface component or network interface controller). The communication component 804 may be configured to communicate over a wired connection (including metallic and optical connections), a wireless connection (e.g., RF signals, optical signals and the like), or a combination of both. Indeed, communication between a user, such as user 101 of FIG. 1, and the provenance engine 104, and/or the communication between the provenance engine and external resources, including an external generative engine 110, is facilitated and carried out by at least one communication component 804 over a network, such as network 160.

As suggested, the computer system 800 hosts and is configured to operate as a provenance engine 104. As such, it contains the various executable components of the provenance engine in a memory/storage 806 including, by way of illustration and not limitation, and as described above in reference to FIG. 2, an orchestration module 202, a generative module 204, a storage module 206, a tools module 208, an optimization module 210 and a user interface module 212. Also included in the memory/storage of the computer system 800 is the data store 108 which may store, by way of illustration and not limitation, items such as cache information for the provenance engine (including cache regarding recent interactions with a generative engine), content sources, chunking information associated with the content sources, user data and/or access credentials.

1. A computer-implemented method for providing content having at least one specific to citation content in a content source, the method comprising at least:
receiving an input prompt for a generated response from a user, the input prompt indicated at least a first topic for a generated response;
providing the input prompt to a generative engine, wherein input prompt provided to the generative engine includes instructions to include at least one specific citation to a content source in the generated response;
receiving a generated response from the generative engine based at least in part to the at least first topic, the generated response including at least a first specific citation correlating cited content in the generated response to citation content in a first content source;
associating a relevance score to the first specific citation based on the relevance of the cited content in the generated response to the citation content of the first content source; and
providing the generated response to the user.

2. The computer-implemented method of claim 1, wherein the input prompt is associated with a list of content sources based on which the generated response is to be generated.

3. The computer-implemented method of claim 2, wherein the list of content sources is an ordered list of content courses indicating a preferred order of reliance for generative engine on which the generated response is to be generated.

4. The computer-implemented method of claim 2, wherein the list of content sources constitutes an exclusive set of content sources based on which the generated response is to be generated.

5. The computer-implemented method of claim 2, wherein the list of content sources is a preferred set of content sources, but not an exclusive set of content sources, based on which the generated response is to be generated.

6. The computer-implemented method of claim 2, wherein the list of content sources identifies at least a first content source that is located at an external location to the generative engine.

7. The computer-implemented method of claim 6, wherein the first content source is associated with access information for the generative engine to assess the first content source from the external location.

8. The computer-implemented method of claim 6 further comprising:
receiving a callback from the generative engine requesting first access credentials for accessing the first content source its external location to the generative engine;
obtaining first access credentials to the first content source; and
returning the first access credentials to the first content source to the generative engine.

9. The computer-implemented method of claim 8, wherein the method further comprises at least:
determining the list of content sources identifies at least a second content source that that is located at an external location to the generative engine;
receiving a second callback from the generative engine requesting access credentials for accessing the second content source from its external location to the generative engine;
obtaining second access credentials to the second content source; and
returning the second access credentials to the second content source to the generative engine;
wherein the first access credentials are not the same as the second access credentials.

10. The computer-implemented method of claim 1, wherein the relevance score is determined according to a semantic similarity analysis of the cited content to the citation content.

11. The computer-implemented method of claim 1, wherein the cited content of the specific citation includes quoted content from the citation content.

12. The computer-implemented method of claim 1, further comprising:
receive a user request to display citation content of a specific citation of a generated response;
access the content source referenced by the specific citation;
determine location within content source of the citation content according to information from the specific citation; and
create a viewer for presenting content to the user and load the content of the citation source in the viewer;
position the presentation of the content such that the citation content is viewable within the viewer; and
present the content of the citation source in the viewer having the citation content immediately displayed in the viewer.

13. The computer-implemented method of claim 1, further comprising preprocessing the input prompt to ensure the input prompt includes instructions for the generative engine to include at least one specific citation in a generated response.

14. A computer-implemented method for responding an input prompt from a user, the method comprising at least:
receiving an input prompt from a user over a communication network, wherein the input prompt is a request for a generated response with respect to a first topic;
preprocessing the input prompt to ensure that the input prompt includes instructions to a generative engine to include at least one specific citation in the generated response;
providing the input prompt to a generative engine;
receiving a generated response from the generative engine, the generated response including at least a first specific citation to citation content of a first content source;
validating that the cited content of the at least first specific citation references content in the first content source;
associating a score with the first specific citation based on a relevance analysis of the cited content of the first specific citation and the citation content of the first content source; and
providing the generated response to the user.

15. The computer-implemented method of claim 14, wherein the generative engine is a generative artificial intelligence (GAI) tool.

16. The computer-implemented method of claim 14, wherein the relevance analysis is carried out by a trained large language model (LLM) configured to determine the score for the relevance analysis based, at least in part, on a determination of a semantic similarity between the first specific citation and the citation content of the first content source.

17. The computer-implemented method of claim 14, the method further comprising at least:
receiving at least a first list referencing content sources which the generative engine is to use in generating the response to the input prompt.

18. The computer-implemented method of claim 14, wherein the first list referencing content sources is an ordered list of content sources indicated a preferential order of content sources which the generative engine is to use in generating the response to the input prompt.

19. A computer-implemented system for responding an input prompt from a user with a generated response, comprising at least:
a processor suitable for executing one or more executable modules that implement a provenance engine suitable for responding to the input prompt from the user with a generated response; and
a memory storing, at least, the one or more executable modules that implement the provenance engine;
wherein, in executing the one or more executable modules that implement the provenance engine, the computer-implemented system is configured to, at least:
receive an input prompt from a user over a communication network, wherein the input prompt is a request for a generated response with respect to a first topic;
preprocess the input prompt to ensure that the input prompt includes instructions to a generative engine to include at least one specific citation in the generated response
provide the input prompt to a generative engine;
receive a generated response from the generative engine, the generated response including at least a first specific citation to a first content source;
validate that the at least first specific citation by determining that the first content source is a valid content source and the citation content of the specific citation is found within the first content source;
associate a score with the first specific citation based on a relevance analysis of the cited content of the first specific citation and the citation content of the first content source; and
provide the generated response to the user.

20. The computer-implemented system of claim 19, wherein the relevance analysis is carried out by a trained large language model (LLM) configured to determine the score of the relevance analysis based, at least in part, on determination of a semantic similarity between the first specific citation and the citation content of the first content source.
